(19) United States
(12) Patent Application Publication
(10) Pub. No.: US 2026/0276715 A1
(43) Pub. Date: Sep. 17, 2026

(54) BATTERY LIFE EARLY WARNING PLATFORM FOR MOBILE ENERGY STORAGE APPARATUS BASED ON BATTERY THERMAL RUNAWAY ANALYSIS

(71) Applicant: NANTONG GUOXUAN NEW ENERGY TECHNOLOGY CO., LTD, Nantong (CN)

(72) Inventors: Wei LIN, Nantong (CN); Chenggang SUN, Nantong (CN); Qinggen PENG, Nantong (CN); Jianjin ZHU, Nantong (CN)

(21) Appl. No.: 19/671,341

(22) Filed: May 8, 2026

Related U.S. Application Data
(63) Continuation of application No. PCT/CN2025/101375, filed on Jun. 17, 2025.

(30) Foreign Application Priority Data
Aug. 27, 2024 (CN) 2024111807751

(51) Int. Cl. G01R 31/371; G01R 31/367; G01R 31/3842; G01R 31/392; G08B 21/18

(52) U.S. Cl. CPC G01R 31/371; G01R 31/367; G01R 31/3842; G01R 31/392; G08B 21/182

(57) ABSTRACT

Disclosed in the present disclosure is a battery life early warning platform for a mobile energy storage apparatus based on battery thermal runaway analysis, relating to battery safety-related fields. The platform includes: a battery thermal runaway parameter set generation device configured to retrieve a historical battery thermal runaway log and generate a battery thermal runaway parameter set; an apparatus battery operating parameter acquisition device configured to perform real-time monitoring and acquire an apparatus battery operating parameter; a parameter comparison device configured to perform comparison and generate a parameter comparison result; a battery life early warning model building device is configured to build a battery life early warning model; an early warning signal output device is configured to acquire a battery state parameter and output an early warning signal; and an intelligent alarm device is configured to activate an alarm device and connect a remote terminal to perform alarming.

### CROSS-REFERENCE TO RELATED APPLICATIONS

This application is a continuation of International Application No. PCT/CN2025/101375, filed on Jun. 17, 2025, which claims priority to Chinese Patent Application No. 202411180775.1, filed on Aug. 27, 2024. All of the aforementioned applications are incorporated herein by reference in their entireties.

### TECHNICAL FIELD

The present disclosure relates to battery safety-related fields, and particularly relates to a battery life early warning platform for a mobile energy storage apparatus based on battery thermal runaway analysis.

### BACKGROUND

A battery is a critical component of a mobile energy storage apparatus, and its life directly affects the overall operational efficiency and safety of the apparatus. Thermal runaway is an extreme phenomenon that occurs during battery charge and discharge due to factors such as an internal short circuit, overcharge, overdischarge, or a high external temperature. A high temperature generated during thermal runaway accelerates chemical reactions inside the battery, causing battery materials to degrade more rapidly and thereby shortening the life of the battery. Existing methods for predicting battery life often rely on experience, simple mathematical models, or statistical methods. When predicting the battery life, these methods tend to ignore the effects of thermal runaway on the battery life or treat it simplistically. Due to insufficient consideration of the effects of thermal runaway on the battery life, performance degradation of the battery in high-temperature environments cannot be accurately predicted, and prediction results contain large errors.

In the related prior art, there is a technical problem regarding low accuracy of prediction results for battery life early warning in mobile energy storage apparatuses.

### SUMMARY

In the present disclosure, a battery life early warning platform for a mobile energy storage apparatus based on battery thermal runaway analysis is provided, a historical battery thermal runaway log is analyzed, then a battery thermal runaway parameter set is generated, real-time monitoring is performed on the mobile energy storage apparatus, parameter comparison is performed, a battery life early warning model is built, an early warning signal is output, and an intelligent alarm is performed for battery life. According to the above technological means, technical effects of improving accuracy and reliability of early warning, and providing a strong guarantee for safe operations of the mobile energy storage apparatus are achieved.

The present disclosure provides a battery life early warning platform for a mobile energy storage apparatus based on battery thermal runaway analysis, including:
a battery thermal runaway parameter set generation device, where the battery thermal runaway parameter set generation device is configured to retrieve a historical battery thermal runaway log to analyze the mobile energy storage apparatus, and generate a battery thermal runaway parameter set, and the battery thermal runaway parameter set includes a thermal runaway reaction parameter and a thermal runaway trigger parameter;
an apparatus battery operating parameter acquisition device, where the apparatus battery operating parameter acquisition device is configured to acquire an apparatus battery operating parameter through real-time monitoring of the mobile energy storage apparatus;
a parameter comparison device, where the parameter comparison device is configured to compare the apparatus battery operating parameter with the thermal runaway reaction parameter by taking the thermal runaway trigger parameter as a constraint condition, and generate a parameter comparison result;
a battery life early warning model building device, where the battery life early warning model building device is configured to build a battery life early warning model and synchronize the parameter comparison result to the battery life early warning model, and the battery life early warning model includes a battery life analysis channel and a battery life early warning channel;
an early warning signal output device, where the early warning signal output device is configured to acquire a battery state parameter through the battery life analysis channel, and input the battery state parameter into the battery life early warning channel to output an early warning signal; and
an intelligent alarm device, where the intelligent alarm device is configured to receive the early warning signal based on the early warning platform to activate an alarm device, and connect a remote terminal through the alarm device to perform intelligent alarming on battery life of the mobile energy storage apparatus.

In a possible implementation, the battery thermal runaway parameter set generation device includes:
a historical operating thermal runaway event extraction unit, where the historical operating thermal runaway event extraction unit is configured to analyze the historical battery thermal runaway log and extract a historical operating thermal runaway event of the mobile energy storage apparatus, and the historical operating thermal runaway event includes thermal runaway time data, thermal runaway location data, and a thermal runaway battery state;
a battery short-circuit trigger record generation unit, where the battery short-circuit trigger record generation unit is configured to perform trigger analysis based on the thermal runaway battery state and generate a battery short-circuit trigger record;
a battery overcharge and overdischarge trigger record generation unit, where the battery overcharge and overdischarge trigger record generation unit is configured to perform trigger analysis based on the thermal runaway battery state in combination with the thermal runaway time data, and generate a battery overcharge trigger record and a battery overdischarge trigger record;
an ambient temperature trigger record generation unit, where the ambient temperature trigger record generation unit is configured to perform trigger analysis based on the thermal runaway location data and generate an ambient temperature trigger record; and
a thermal runaway trigger parameter determination unit, where the thermal runaway trigger parameter determination unit is configured to integrate the battery short-circuit trigger record, the battery overcharge trigger record, the battery overdischarge trigger record, and the ambient temperature trigger record to determine the thermal runaway trigger parameter.

In a possible implementation, the battery thermal runaway parameter set generation device includes:
a thermal runaway temperature record data acquisition unit, where the thermal runaway temperature record data acquisition unit is configured to identify a battery state change of the mobile energy storage apparatus according to the historical operating thermal runaway event, and acquire thermal runaway temperature record data, and the thermal runaway temperature record data includes a thermal runaway initial temperature, a thermal runaway peak temperature, and a thermal runaway temperature change rate;
a thermal runaway voltage and current data acquisition unit, where the thermal runaway voltage and current data acquisition unit is configured to analyze a power parameter change in the historical operating thermal runaway event, and acquire thermal runaway voltage data and thermal runaway current data;
a thermal runaway reaction rate data acquisition unit, where the thermal runaway reaction rate data acquisition unit is configured to perform calculations based on the thermal runaway voltage data and the thermal runaway current data, and obtain thermal runaway reaction rate data; and
a thermal runaway reaction parameter determination unit, where the thermal runaway reaction parameter determination unit is configured to integrate the thermal runaway temperature record data and the thermal runaway reaction rate data to determine the thermal runaway reaction parameter.

In a possible implementation, the parameter comparison device includes:
a plurality of trigger frequency determination units, where the plurality of trigger frequency determination units are configured to determine a plurality of trigger frequencies based on the battery short-circuit trigger record, the battery overcharge trigger record, the battery overdischarge trigger record, and the ambient temperature trigger record;
a constraint condition determination unit, where the constraint condition determination unit is configured to extract, based on the plurality of trigger frequencies, a trigger record that leads to a battery thermal runaway result, and determine the constraint condition;
a thermal runaway critical value determination unit, where the thermal runaway critical value determination unit is configured to analyze a thermal runaway characteristic according to the thermal runaway initial temperature, the thermal runaway peak temperature, and the thermal runaway temperature change rate, and determine a thermal runaway critical value;
a comparison and determination unit, where the comparison and determination unit is configured to compare the apparatus battery operating parameter and the thermal runaway reaction parameter according to the constraint condition, and determine whether the apparatus battery operating parameter reaches the thermal runaway critical value;
a battery thermal runaway risk parameter acquisition unit, where the battery thermal runaway risk parameter acquisition unit is configured to determine that the mobile energy storage apparatus has a battery thermal runaway risk in a case where the apparatus battery operating parameter reaches the thermal runaway critical value, and acquire a battery thermal runaway risk parameter, and
a parameter comparison result adding unit, where the parameter comparison result adding unit is configured to add the battery thermal runaway risk parameter to the parameter comparison result.

In a possible implementation, the battery life early warning model building device includes:
a life influencing feature extraction unit, where the life influencing feature extraction unit is configured to extract a life influencing feature according to a battery life influencing parameter of the mobile energy storage apparatus;
a plurality of decision tree building units, where the plurality of decision tree building units are configured to use a random forest to build a plurality of decision trees based on the life influencing feature;
a battery life analysis channel building unit, where the battery life analysis channel building unit is configured to perform cross-validation on the plurality of decision trees, and build the battery life analysis channel;
a splitting criterion performance unit, where the splitting criterion performance unit is configured to perform splitting criteria on the plurality of decision trees according to a maximum depth, and generate a performance result;
a battery life early warning channel building unit, where the battery life early warning channel building unit is configured to perform unsupervised training for battery life on the mobile energy storage apparatus based on the performance result, and build the battery life early warning channel according to a training result; and
a channel fusion unit, where the channel fusion unit is configured to fuse the battery life analysis channel and the battery life early warning channel, and build the battery life early warning model.

In a possible implementation, the early warning signal output device includes:
a battery thermal runaway risk parameter input unit, where the battery thermal runaway risk parameter input unit is configured to extract the battery thermal runaway risk parameter from the parameter comparison result, and input the battery thermal runaway risk parameter into the battery life analysis channel;
a battery life decline rate data generation unit, where the battery life decline rate data generation unit is configured to calculate a change trend according to the battery thermal runaway risk parameter and the apparatus battery operating parameter, and generate battery life decline rate data;
a remaining battery life data generation unit, where the remaining battery life data generation unit is configured to perform life evaluation on the mobile energy storage apparatus according to the battery life decline rate data, and generate remaining battery life data; and
a battery state parameter output unit, where the battery state parameter output unit is configured to integrate the battery life decline rate data and the remaining battery life data to output the battery state parameter through the battery life analysis channel.

In a possible implementation, the early warning signal output device includes:
a battery state parameter analysis unit, where the battery state parameter analysis unit is configured to analyze the battery state parameter and acquire a battery life percentage, a battery cycle count, and battery usage time;
a threshold setting unit, where the threshold setting unit is configured to set a minimum battery life percentage threshold based on the battery life percentage, set a remaining battery cycle threshold based on the battery cycle count, and set a maximum battery usage time threshold based on the battery usage time;
a remaining battery life data extraction unit, where the remaining battery life data extraction unit is configured to extract a remaining battery life percentage, a remaining battery cycle count, and battery usage time of the remaining battery life data based on the battery life decline rate data,
a first early warning signal generation unit, where the first early warning signal generation unit is configured to generate a first early warning signal in a case where the battery usage time is greater than or equal to the maximum battery usage time threshold;
a second early warning signal generation unit, where the second early warning signal generation unit is configured to determine, in a case where the battery usage time is less than the maximum battery usage time threshold, whether the remaining battery cycle count is less than the remaining battery cycle threshold, and generate, if so, a second early warning signal;
a third early warning signal generation unit, where the third early warning signal generation unit is configured to determine, in a case where the battery usage time is less than the maximum battery usage time threshold and the remaining battery cycle count is greater than or equal to the remaining battery cycle threshold, whether the remaining battery life percentage is less than or equal to the minimum battery life percentage threshold, and generate, if so, a third early warning signal; and
an early warning response unit, where the early warning response unit is configured to perform an early warning response based on the first early warning signal, the second early warning signal, and the third early warning signal, and output the early warning signal.

In a possible implementation, the intelligent alarm device includes:
an abnormal parameter set acquisition unit, where the abnormal parameter set acquisition unit is configured to decompose the early warning signal to acquire an abnormal parameter set, and send the abnormal parameter set to the remote terminal through the alarm device for alarming;
an adjustment parameter set generation unit, where the adjustment parameter set generation unit is configured to return a battery optimization strategy through the remote terminal, perform the battery optimization strategy in combination with the apparatus battery operating parameter to adjust an initial battery usage strategy of the mobile energy storage apparatus, and generate an adjustment parameter set;
a parameter adjustment unit, where the parameter adjustment unit is configured to adjust the thermal runaway time data, the thermal runaway location data, and the thermal runaway battery state according to the adjustment parameter set, and acquire a battery usage time adjustment parameter, a battery usage location adjustment parameter, and a battery usage state adjustment parameter; and
a battery life data update unit, where the battery life data update unit is configured to update battery life data of the mobile energy storage apparatus based on the battery usage time adjustment parameter, the battery usage location adjustment parameter, and the battery usage state adjustment parameter.

Through the battery life early warning platform for a mobile energy storage apparatus based on battery thermal runaway analysis provided in the present disclosure, the battery thermal runaway parameter set generation device retrieves the historical battery thermal runaway log to analyze the mobile energy storage apparatus, and generates the battery thermal runaway parameter set. The battery thermal runaway parameter set includes the thermal runaway reaction parameter and the thermal runaway trigger parameter. The apparatus battery operating parameter acquisition device acquires the apparatus battery operating parameter through real-time monitoring of the mobile energy storage apparatus. The parameter comparison device compares the apparatus battery operating parameter with the thermal runaway reaction parameter by taking the thermal runaway trigger parameter as a constraint condition, and generates the parameter comparison result. The battery life early warning model building device builds the battery life early warning model and synchronizes the parameter comparison result to the battery life early warning model. The battery life early warning model includes the battery life analysis channel and the battery life early warning channel. The early warning signal output device acquires the battery state parameter through the battery life analysis channel, and inputs the battery state parameter into the battery life early warning channel to output the early warning signal. The intelligent alarm device receives the early warning signal based on the early warning platform to activate the alarm device, and connects the remote terminal through the alarm device to perform intelligent alarming on the battery life of the mobile energy storage apparatus. The technical effects of improving accuracy and reliability of early warning, and providing a strong guarantee for safe operations of the mobile energy storage apparatus are achieved.

### BRIEF DESCRIPTION OF THE DRAWINGS

In order to explain the technical solutions of the embodiments of the present disclosure more clearly, the drawings of the embodiments of the present disclosure will be briefly introduced below. A flowchart is used in the present disclosure to illustrate operations performed by the platform according to the embodiments of the present disclosure. It should be understood that the preceding or following operations are not necessarily performed in exact order. Instead, the various steps can be processed in reverse order or simultaneously, as appropriate. Moreover, other operations can be added to these processes, or one or more steps can be removed from these processes.

FIG. 1 is a schematic structural diagram of a battery life early warning platform for a mobile energy storage apparatus based on battery thermal runaway analysis provided in an embodiment of the present disclosure; and

FIG. 2 is a schematic structural diagram of an early warning signal output device of a battery life early warning platform for a mobile energy storage apparatus based on battery thermal runaway analysis provided in an embodiment of the present disclosure.

### REFERENCE NUMERALS

battery thermal runaway parameter set generation device 10, apparatus battery operating parameter acquisition device 20, parameter comparison device 30, battery life early warning model building device 40, early warning signal output device 50, and intelligent alarm device 60.

### DETAILED DESCRIPTION OF THE EMBODIMENTS

The above description is merely an overview of the technical solutions of the present application. In order to more clearly understand the technical means of the present application, the present application can be implemented according to the contents of the specification, and in order to make the above and other objects, features and advantages of the present application more obvious and comprehensible, specific embodiments of the present application are particularly given below.

In order to make the purpose, technical solutions and advantages of the present disclosure clearer, the present disclosure will be described in further detail below in conjunction with the accompanying drawings. The described embodiments should not be regarded as limiting the present disclosure. All other embodiments obtained by those of ordinary skill in the art without making creative efforts fall within the scope of protection of the present disclosure.

In the following description, “some embodiments” describe a subset of all possible embodiments, but it can be understood that “some embodiments” may be a same subset or a different subset of all possible embodiments, and may be combined with each other without conflict. The terms “first/second” involved are only used to distinguish similar objects and do not represent a specific ordering of the objects. The terms “comprise”, “include”, “have”, and their any variants are intended to cover the non-exclusive inclusion. For example, a process, platform, product, or server that includes a series of steps or units is not necessarily limited to those steps or units expressly listed, but can include other steps or units not expressly listed or inherent to such a process, product, or apparatus. Unless defined otherwise, all the technical and scientific terms used herein have the same meaning as those commonly understood by those skilled in the art to which the present disclosure pertains. The terms used herein are merely used to describe embodiments of the present disclosure.

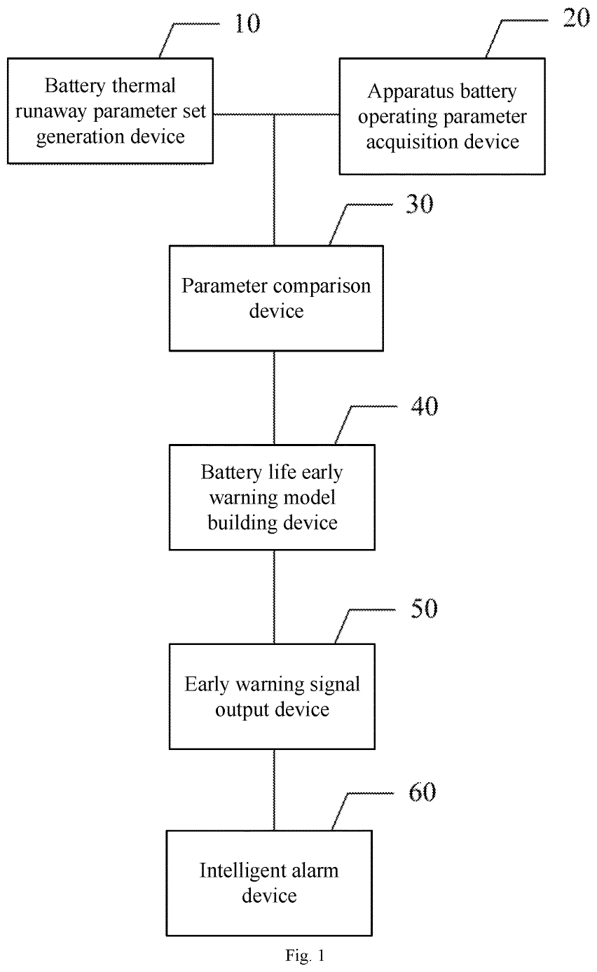

The embodiments of the present disclosure provide a battery life early warning platform for a mobile energy storage apparatus based on battery thermal runaway analysis. As shown in FIG. 1, the platform includes:
a battery thermal runaway parameter set generation device 10, where the battery thermal runaway parameter set generation device 10 is configured to retrieve a historical battery thermal runaway log to analyze the mobile energy storage apparatus, and generate a battery thermal runaway parameter set. The battery thermal runaway parameter set includes a thermal runaway reaction parameter and a thermal runaway trigger parameter. The mobile energy storage apparatus is referred to as a mobile apparatus that can store electrical energy and release the electrical energy when needed, such as an electric vehicle and a portable power supply. Specifically, the battery thermal runaway parameter set generation device 10 accesses a database or data warehouse that stores the historical battery thermal runaway log, performs query operations, and retrieves relevant historical log data according to preset filtering conditions (such as a model and a battery type of the mobile energy storage apparatus). Preprocessing on the historical battery thermal runaway log includes data cleaning (removing duplicate, erroneous or invalid data), data conversion (converting data into a unified format or unit), data interpolation (filling in missing values), etc., to improve data quality. Key parameters related to a thermal runaway reaction and thermal runaway triggering are extracted from the preprocessed data through statistical methods, data mining algorithms or expert knowledge. Battery thermal runaway is a phenomenon in which temperature in a battery rises sharply due to factors such as internal short circuit, overcharge, overdischarge, and external high temperature during charging, discharging, storage, or transportation, then a series of uncontrollable chemical reactions and physical changes are triggered, and serious consequences such as battery fire or explosion may be caused eventually. The thermal runaway reaction parameters describe physical or chemical parameters, such as changing trends and thresholds of battery temperature, voltage, current, internal pressure, etc., displayed by a battery in a thermal runaway state. These parameters are an important basis for determining whether the battery is in the thermal runaway state. The thermal runaway trigger parameters are specific conditions or parameter values, such as a temperature rise rate and a voltage fluctuation range, that can trigger battery thermal runaway. These parameters are key indicators for preventing battery thermal runaway. Methods such as statistical analysis, machine learning algorithms or physical models are used to analyze a relationship, change patterns and triggering conditions between the parameters. Analyzed thermal runaway reaction parameters (such as changing ranges or thresholds of the temperature, voltage and other parameters of the battery during thermal runaway) and thermal runaway trigger parameters (such as temperature rise rate and the voltage fluctuation range) are organized to generate the battery thermal runaway parameter set.

In a possible implementation, the battery thermal runaway parameter set generation device 10 includes a historical operating thermal runaway event extraction unit. The historical operating thermal runaway event extraction unit is configured to analyze the historical battery thermal runaway log and extract a historical operating thermal runaway event of the mobile energy storage apparatus. The historical operating thermal runaway event includes thermal runaway time data, thermal runaway location data, and a thermal runaway battery state. Specifically, a historical operating thermal runaway event record related to the mobile energy storage apparatus is filtered from the historical battery thermal runaway log. A thermal runaway event indicates a thermal runaway phenomenon of a battery caused by internal or external factors, and is usually accompanied by a sharp rise in temperature and possible safety hazards. The thermal runaway time data (such as year, month, day, hour, minute, second), the thermal runaway location data (such as longitude and latitude, specific address), and the thermal runaway battery state (such as voltage, current, temperature, remaining battery percentage, etc.) are extracted from the filtered historical operating thermal runaway event record. A battery short-circuit trigger record generation unit is included. The battery short-circuit trigger record generation unit is configured to perform trigger analysis based on the thermal runaway battery state and generate a battery short-circuit trigger record. Specifically, the extracted thermal runaway battery state is analyzed, and an abnormal state related to a short circuit is identified. A battery short circuit indicates that a positive electrode and a negative electrode in a battery are directly connected for some reason, causing a current to bypass a normal path, and then serious thermal runaway phenomena, such as voltage sag, current surge, etc., may be caused. Based on the abnormal state related to a short circuit, whether thermal runaway is caused by the short circuit is determined, and the corresponding battery short-circuit trigger record is generated. A battery overcharge and overdischarge trigger record generation unit is included. The battery overcharge and overdischarge trigger record generation unit is configured to perform trigger analysis based on the thermal runaway battery state in combination with the thermal runaway time data, and generate a battery overcharge trigger record and a battery overdischarge trigger record. Specifically, the thermal runaway time data is associated with the thermal runaway battery state. A charge and discharge state of the battery before and after thermal runaway is analyzed. Based on the charge and discharge state before and after thermal runaway, whether thermal runaway is caused by overcharging or overdischarging is determined. The corresponding battery overcharge trigger record and battery overdischarge trigger record are generated. Overcharge indicates that a battery exceeds a maximum charge voltage or charge time allowed by its design during charge, and excessive internal pressure and temperature rise in the battery may be caused, leading to thermal runaway. Overdischarge indicates that a battery is lower than a minimum discharge voltage allowed by its design or has an excessive discharge depth during discharge, and changes in an internal material structure of the battery may be caused, leading to thermal runaway. An ambient temperature trigger record generation unit is included. The ambient temperature trigger record generation unit is configured to perform trigger analysis based on the thermal runaway location data and generate an ambient temperature trigger record; and specifically, the extracted thermal runaway location data is analyzed, and ambient temperature information when thermal runaway occurs is acquired. An ambient temperature indicates an external temperature condition when a battery is running. Whether the ambient temperature when thermal runaway occurs is abnormal (too high or too low temperatures may influence battery performance and safety) is analyzed, and whether the temperature is one of external factors causing thermal runaway is determined. Based on a temperature analysis results, the ambient temperature trigger record is generated. A thermal runaway trigger parameter determination unit is included. The thermal runaway trigger parameter determination unit is configured to integrate the battery short-circuit trigger record, the battery overcharge trigger record, the battery overdischarge trigger record, and the ambient temperature trigger record to determine the thermal runaway trigger parameter. Specifically, the battery short-circuit trigger record, the battery overcharge trigger record, the battery overdischarge trigger record, and the ambient temperature trigger record are integrated. Based on an integrated trigger record, the thermal runaway trigger parameters are determined, including a voltage threshold, a current threshold, a temperature threshold, a charge and discharge time threshold, etc. According to the implementation, the historical operating thermal runaway event extraction unit, the battery short-circuit trigger record generation unit, the battery overcharge and overdischarge trigger record generation unit, the ambient temperature trigger record generation unit, and the thermal runaway trigger parameter determination unit are set. Accordingly, key factors leading to thermal runaway are identified from a plurality of dimensions (short circuit, overcharge, overdischarge, and ambient temperature). The corresponding trigger records are generated. By integrating these trigger records, the thermal runaway trigger parameters are accurately determined. A technical effect of improving accuracy of thermal runaway trigger parameter determination is achieved.

In a possible implementation, the battery thermal runaway parameter set generation device 10 includes a thermal runaway temperature record data acquisition unit. The thermal runaway temperature record data acquisition unit is configured to identify a battery state change of the mobile energy storage apparatus according to the historical operating thermal runaway event, and acquire thermal runaway temperature record data. The thermal runaway temperature record data includes a thermal runaway initial temperature, a thermal runaway peak temperature, and a thermal runaway temperature change rate. Specifically, a thermal runaway event related to the battery state change of the mobile energy storage apparatus is identified according to the historical operating thermal runaway event record. Temperature-related data is extracted from the identified thermal runaway event, including the thermal runaway initial temperature (that is, a temperature of the battery when thermal runaway begins), the thermal runaway peak temperature (that is, a highest temperature reached by the battery during thermal runaway), and the thermal runaway temperature change rate (that is, a rate of a temperature change over time). A thermal runaway voltage and current data acquisition unit is included. The thermal runaway voltage and current data acquisition unit is configured to analyze a power parameter change in the historical operating thermal runaway event, and acquire thermal runaway voltage data and thermal runaway current data. Specifically, power parameters (voltage, current) in the historical operating thermal runaway event are analyzed. The thermal runaway voltage data (that is, a battery voltage change during thermal runaway) and the thermal runaway current data (that is, a battery current change during thermal runaway) are extracted from an analysis result. A thermal runaway reaction rate data acquisition unit is included. The thermal runaway reaction rate data acquisition unit is configured to perform calculations based on the thermal runaway voltage data and the thermal runaway current data, and obtain thermal runaway reaction rate data. Specifically, based on the obtained thermal runaway voltage data and thermal runaway current data, differential processing or other mathematical operations are performed to obtain the thermal runaway reaction rate data. A thermal runaway reaction rate indicates a speed of a chemical reaction or physical process in a battery during thermal runaway. A thermal runaway reaction parameter determination unit is included. The thermal runaway reaction parameter determination unit is configured to integrate the thermal runaway temperature record data and the thermal runaway reaction rate data to determine the thermal runaway reaction parameter. Specifically, the obtained thermal runaway temperature record data and thermal runaway reaction rate data are integrated, and the thermal runaway reaction parameter is determined based on integrated data. The thermal runaway reaction parameter describes key characteristics, such as a temperature threshold and a reaction rate threshold, of the battery during thermal runaway. According to the implementation, the thermal runaway temperature record data acquisition unit, the thermal runaway voltage and current data acquisition unit, the thermal runaway reaction rate data acquisition unit, and the thermal runaway reaction parameter determination unit are set. Accordingly, a battery thermal runaway event is comprehensively analyzed from a plurality of dimensions, and key thermal runaway reaction parameters are obtained. A technical effect of providing accurate data support for accurately predicting and evaluating battery thermal runaway risks is achieved.

An apparatus battery operating parameter acquisition device 20 is included. The apparatus battery operating parameter acquisition device 20 is configured to acquire an apparatus battery operating parameter through real-time monitoring of the mobile energy storage apparatus. The apparatus battery operating parameter indicates various physical and chemical parameters displayed by the battery during operation. Specifically, the apparatus battery operating parameter acquisition device 20 is a device configured to monitor the mobile energy storage apparatus in real time and obtain the battery operating parameters. When the apparatus battery operating parameter acquisition device 20 is started, initialization settings are performed, including setting the frequency of data collection, configuration of a communication interface, a data storage format, etc. Communication connection is established with the mobile energy storage apparatus in a wired or wireless manner. A model, a battery type and related configuration information of the connected mobile energy storage apparatus are identified. A real-time monitoring program is started. Data collection is performed on the battery of the mobile energy storage apparatus according to the preset frequency of data collection. The battery operating parameters are read from a battery management system or other related sensors of the mobile energy storage apparatus. The battery operating parameters include, but are not limited to, a voltage, a current, a temperature, a charge/discharge state, a remaining power percentage, a health state, etc. of the battery.

A parameter comparison device 30 is included. The parameter comparison device 30 is configured to compare the apparatus battery operating parameter with the thermal runaway reaction parameter by taking the thermal runaway trigger parameter as a constraint condition, and generate a parameter comparison result. Specifically, the parameter comparison device 30 receives the thermal runaway trigger parameter and the thermal runaway reaction parameter from the battery thermal runaway parameter set generation device 10, and the apparatus battery operating parameters from the apparatus battery operating parameter acquisition device 20. The received apparatus battery operating parameters are matched with the thermal runaway trigger parameter, to make compared data types, units, etc. consistent. Then the matched apparatus battery operating parameter and the thermal runaway reaction parameter are comparatively analyzed to evaluate similarity between a current state and the thermal runaway state of the battery. A thermal runaway risk of the battery is evaluated according to comparison results between the apparatus battery operating parameters and the thermal runaway trigger parameter as well as the thermal runaway reaction parameter. In a case where the apparatus battery operating parameter is close to or exceeds the thermal runaway trigger parameter, or is similar to the thermal runaway reaction parameter, the battery is considered to be at thermal runaway risk or is already in the thermal runaway state. The parameter comparison result is generated based on results of comparative analysis and risk assessment.

In a possible implementation, the parameter comparison device 30 includes a plurality of trigger frequency determination units. The plurality of trigger frequency determination units are configured to determine a plurality of trigger frequencies based on the battery short-circuit trigger record, the battery overcharge trigger record, the battery overdischarge trigger record, and the ambient temperature trigger record. Specifically, a number and frequency of each of the above trigger records occurring per unit time are counted. Specific influences of each trigger on the battery are analyzed, including battery performance decline, shortened life, etc. A trigger frequency and impact analysis of each trigger record are output. A constraint condition determination unit is included. The constraint condition determination unit is configured to extract, based on the plurality of trigger frequencies, a trigger record that leads to a battery thermal runaway result, and determine the constraint condition. Specifically, the trigger record that ultimately leads to battery thermal runaway is filtered out from all the trigger records. Common features or conditions are extracted from the filtered trigger record. The constraint condition (specific condition or standard) for determining the battery thermal runaway risk is set based on the extracted features or conditions. A thermal runaway critical value determination unit is included. The thermal runaway critical value determination unit is configured to analyze a thermal runaway characteristic according to the thermal runaway initial temperature, the thermal runaway peak temperature, and the thermal runaway temperature change rate, and determine a thermal runaway critical value. The thermal runaway critical value indicates that during battery thermal runaway, in a case where a parameter reaches or exceeds a specific value, it is considered that the battery has or is about to undergo thermal runaway. Specifically, the characteristics of the battery during thermal runaway are analyzed according to the parameters such as the thermal runaway initial temperature, the thermal runaway peak temperature, and the thermal runaway temperature change rate. The thermal runaway critical value, such as a temperature threshold and a change rate threshold, is set based on thermal runaway characteristic analysis. A comparison and determination unit is included. The comparison and determination unit is configured to compare the apparatus battery operating parameter and the thermal runaway reaction parameter according to the constraint condition, and determine whether the apparatus battery operating parameter reaches the thermal runaway critical value. Specifically, the comparison and determination unit acquires the apparatus battery operating parameter and the thermal runaway reaction parameter, and compares the apparatus battery operating parameter and the thermal runaway reaction parameter to determine whether the apparatus battery operating parameter reaches or exceeds the set thermal runaway critical value, and outputs a determination result. A battery thermal runaway risk parameter acquisition unit is included. The battery thermal runaway risk parameter acquisition unit is configured to determine that the mobile energy storage apparatus has a battery thermal runaway risk in a case where the apparatus battery operating parameter reaches the thermal runaway critical value, and acquire a battery thermal runaway risk parameter. Specifically, when the apparatus battery operating parameter reaches the thermal runaway critical value, it is identified that the battery has the thermal runaway risk. Parameters related to the thermal runaway risk, such as temperature, voltage, current, etc., are extracted from real-time apparatus battery operating parameter data. The battery thermal runaway risk parameter is output. The battery thermal runaway risk parameter indicates a parameter or indicator that can reflect a degree of the battery thermal runaway risk. A parameter comparison result adding unit is included. The parameter comparison result adding unit is configured to add the battery thermal runaway risk parameter to the parameter comparison result. Specifically, the parameter comparison result is a final conclusion or report about the battery thermal runaway risk obtained by the parameter comparison device 30 after a series of comparison, analysis, and determination. According to the implementation, the plurality of trigger frequency determination units, the constraint condition determination unit, the thermal runaway critical value determination unit, the comparison and determination unit, the battery thermal runaway risk parameter acquisition unit, and the parameter comparison result adding unit are set. Accordingly, comprehensiveness and accuracy of the parameter comparison device 30 are achieved. A technical effect of improving accuracy of parameter comparison is improved.

A battery life early warning model building device 40 is included. The battery life early warning model building device 40 is configured to build a battery life early warning model and synchronize the parameter comparison result to the battery life early warning model. The battery life early warning model includes a battery life analysis channel and a battery life early warning channel. Specifically, the battery life early warning model building device 40 is configured to select or design a battery life early warning model structure based on historical battery thermal runaway data and according to a battery type, a specification, a usage environment, etc. The battery life early warning model is a prediction model configured to predict remaining life of the battery and generate an early warning signal. The battery life early warning model can evaluate and evaluate a health condition of the battery according to historical data and a real-time operating state, and includes the battery life analysis channel and the battery life early warning channel. The battery life analysis channel is configured to analyze a current state and a future trend of the battery, and evaluate and predict the health condition of the battery. The battery life early warning channel generates the early warning signal based on the analysis result. When the health condition of the battery is lower than a preset threshold, the early warning channel triggers the early warning signal, such that corresponding measures can be taken in time. The historical data and expert knowledge are used to initialize the battery life early warning model. Initial parameters and thresholds are set. The preprocessed historical battery thermal runaway data and an initial structure of the battery life early warning model are used to train the model. The initial parameters of the battery life early warning model are adjusted through iterative optimization algorithms (such as gradient descent methods and genetic algorithms), such that the battery life early warning model can better fit the historical battery thermal runaway data and predict the future trend. After training is completed, the battery life early warning model is obtained. The parameter comparison result generated by the parameter comparison device 30 is synchronized to the battery life early warning model.

In a possible implementation, the battery life early warning model building device 40 includes a life influencing feature extraction unit. The life influencing feature extraction unit is configured to extract a life influencing feature according to a battery life influencing parameter of the mobile energy storage apparatus. The life influencing feature indicates various parameters or indicators that can influence the battery life and is used to accurately predict the remaining life of the battery. Specifically, the battery life influencing parameter, such as a charge count, a discharge count, a temperature, a current, and a voltage, of the mobile energy storage apparatus is collected. Collected data is subjected to preprocessing such as missing value filling, outlier processing, and data standardization, and features closely related to battery life, such as charging capacity attenuation rate. Features, such as a charging capacity decay rate and an internal resistance growth rate, closely related to the battery life are extracted from the preprocessed data through statistical methods, domain knowledge, or machine learning algorithms. A plurality of decision tree building units are included. The plurality of decision tree building units are configured to use a random forest to build a plurality of decision trees based on the life influencing feature. The decision tree is a machine learning algorithm that uses a tree structure to represent a relationship between features and labels in data. The random forest is an ensemble learning method based on decision trees and can improve accuracy and stability of the model by building the plurality of decision trees and synthesizing their prediction results. Specifically, the extracted life influencing feature data set is divided into a training set and a test set. Training set data is used to build the plurality of decision trees through a random forest algorithm. In a building process, each of the plurality of decision trees randomly selects some features and some samples for training. A battery life analysis channel building unit is included. The battery life analysis channel building unit is configured to perform cross-validation on the plurality of decision trees, and build the battery life analysis channel. Specifically, test set data is used to perform cross-validation on the plurality of decision trees. Prediction performance of each of the plurality of decision trees is evaluated. Decision trees with better performance are selected according to cross-validation results for integration. The battery life analysis channel is built. The battery life analysis channel is configured to analyze the current state and the future trend of the battery according to the input life influencing feature. A splitting criterion performance unit is included. The splitting criterion performance unit is configured to perform splitting criteria on the plurality of decision trees according to a maximum depth, and generate a performance result. Specifically, in order to prevent overfitting, a maximum depth limit is set for the decision trees. In the process of building the decision trees, the trees are pruned according to the maximum depth limit, such that a depth of each of the trees does not exceed a set maximum value. Moreover, during splitting of each node, optimal splitting features and splitting points are selected based on splitting criteria such as information gain and Gini index. A battery life early warning channel building unit is included. The battery life early warning channel building unit is configured to perform unsupervised training for battery life on the mobile energy storage apparatus based on the performance result, and build the battery life early warning channel according to a training result. Specifically, unsupervised training for the battery life is performed on the mobile energy storage apparatus based on the extracted life influencing feature. Unsupervised training is used to discover potential structures and patterns in the data. No label data is required. Battery life early warning thresholds are set according to the training result and domain knowledge. When battery state parameters reach or exceed these thresholds, the early warning signal is triggered. The battery life early warning channel is constructed based on the unsupervised training result and the early warning thresholds. The battery life early warning channel can generate the early warning signal in real time according to the input battery state parameters. A channel fusion unit is included. The channel fusion unit is configured to fuse the battery life analysis channel and the battery life early warning channel, and build the battery life early warning model. Specifically, the battery life analysis channel and the battery life early warning channel are integrated to form a complete battery life early warning model. According to the implementation, the life influencing feature extraction unit, the plurality of decision tree building units, the battery life analysis channel building unit, the splitting criterion performance unit, the battery life early warning channel building unit, and the channel fusion unit are set. Accordingly, an efficient, accurate, and reliable battery life early warning model is built. A technical effect of enabling the battery life early warning model to accurately predict the remaining life of the battery and issue the early warning signal in a timely manner is achieved.

An early warning signal output device 50 is included. The early warning signal output device 50 is configured to acquire a battery state parameter through the battery life analysis channel, and input the battery state parameter into the battery life early warning channel to output an early warning signal. Specifically, the early warning signal output device 5 acquires the battery state parameter of the mobile energy storage apparatus from the battery life analysis channel. The battery state parameter is obtained after analysis based on the input parameter comparison result and reflects the current state or health condition of the battery. The battery state parameter is input into the battery life early warning channel. The battery life early warning channel determines the current state of the battery according to the input battery state parameter or the extracted feature, and determines, according to the preset threshold (for example, a battery capacity is lower than a percentage, a temperature exceeds an upper limit, etc.) in the battery life early warning channel, whether the early warning signal needs to be generated. In a case where an early warning condition is satisfied, the early warning signal output device 50 generates a corresponding early warning signal and outputs the early warning signal to the intelligent alarm device 60.

In a possible implementation, the early warning signal output device 50 includes a battery thermal runaway risk parameter input unit. The battery thermal runaway risk parameter input unit is configured to extract the battery thermal runaway risk parameter from the parameter comparison result, and input the battery thermal runaway risk parameter into the battery life analysis channel. Specifically, the battery thermal runaway risk parameter is extracted from the parameter comparison result. The battery thermal runaway risk parameter is input into the battery life analysis channel. A battery life decline rate data generation unit is included. The battery life decline rate data generation unit is configured to calculate a change trend according to the battery thermal runaway risk parameter and the apparatus battery operating parameter, and generate battery life decline rate data. Specifically, the battery life decline rate data generation unit receives the battery thermal runaway risk parameter and the apparatus battery operating parameter, analyzes changing trends of the battery thermal runaway risk parameter and the apparatus battery operating parameter, and calculates a rate of the battery performance decline, that is, a battery life decline rate. The battery life decline rate is used to describe a speed of the battery performance decline over time, and can be measured by an indicator such as a capacity decay rate or an internal resistance increase rate, where a calculation result is saved as the battery life decline rate data. A remaining battery life data generation unit is included. The remaining battery life data generation unit is configured to perform life evaluation on the mobile energy storage apparatus according to the battery life decline rate data, and generate remaining battery life data. Specifically, the remaining battery life data generation unit receives the battery life decline rate data, evaluates the life of the battery of the mobile energy storage apparatus according to the current performance state, usage history, and an expected life decline rate of the battery, and generates the remaining battery life data, that is, predicts how long or how much a battery will last in the future. A battery state parameter output unit is included. The battery state parameter output unit is configured to integrate the battery life decline rate data and the remaining battery life data to output the battery state parameter through the battery life analysis channel. Specifically, the battery state parameter output unit integrates the battery life decline rate data and the remaining battery life data, and outputs these integrated battery state parameters to the battery life early warning channel through the battery life analysis channel. According to implementation method, the battery thermal runaway risk parameter input unit, the battery life decline rate data generation unit, the remaining battery life data generation unit, and the battery state parameter output unit are set. Accordingly, a battery state parameter set that comprehensively reflects the current state, a performance decline rate, the remaining life and other information of the battery is obtained. A technical effect of providing accurate data input for the battery life early warning channel, thereby improving accuracy and reliability of battery life early warning is achieved.

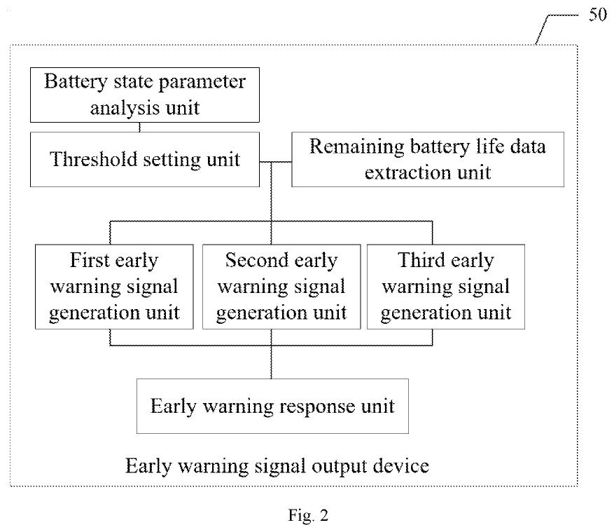

As shown in FIG. 2, in a possible implementation, the early warning signal output device 50 includes a battery state parameter analysis unit. The battery state parameter analysis unit is configured to analyze the battery state parameter and acquire a battery life percentage, a battery cycle count, and battery usage time. Specifically, the battery state parameter analysis unit receives the battery state parameter from the battery life analysis channel, and extracts information of the battery life percentage, the battery cycle count, and the battery usage time. The battery life percentage represents a percentage of current service life to original life of the battery. The battery cycle count represents a number of complete charge and discharge of the battery from a new state to the current state. The battery usage time represents total time that has elapsed from the new state to the current state of the battery. A threshold setting unit is included. The threshold setting unit is configured to set a minimum battery life percentage threshold based on the battery life percentage, set a remaining battery cycle threshold based on the battery cycle count, and set a maximum battery usage time threshold based on the battery usage time. Specifically, the threshold setting unit sets the minimum battery life percentage threshold according to factors such as a battery type and a usage scenario. When remaining battery life is lower than the minimum battery life percentage threshold, the battery is considered to need to be replaced or repaired. The remaining battery cycle threshold is set according to battery design and manufacturer recommendations. When a remaining battery cycle count is lower than the remaining battery cycle threshold, the battery performance is considered to have significantly declined. The maximum battery usage time threshold is set according to battery usage history and maintenance records. The maximum battery usage time threshold is total time from the new state to a service life limit of the battery. A remaining battery life data extraction unit is included. The remaining battery life data extraction unit is configured to extract a remaining battery life percentage, a remaining battery cycle count, and battery usage time of the remaining battery life data based on the battery life decline rate data. Specifically, the remaining battery life data extraction unit receives the battery life decline rate data, and calculates and extracts the remaining battery life percentage, the remaining battery cycle count, and the battery usage time of the remaining battery life data according to the battery life decline rate data in combination with the current battery state parameter. A first early warning signal generation unit is included. The first early warning signal generation unit is configured to generate a first early warning signal in a case where the battery usage time is greater than or equal to the maximum battery usage time threshold. Specifically, current battery usage time is compared with the maximum battery usage time threshold. In a case where the current battery usage time is greater than or equal to the maximum battery usage time threshold, the first early warning signal is generated, indicating that the battery has reached or exceeded a maximum usage time limit. A second early warning signal generation unit is included. The second early warning signal generation unit is configured to determine, in a case where the battery usage time is less than the maximum battery usage time threshold, whether the remaining battery cycle count is less than the remaining battery cycle threshold, and generate, if so, a second early warning signal. Specifically, for a battery whose battery usage time is less than the maximum battery usage time threshold, whether the remaining battery cycle count is less than the remaining battery cycle threshold is further determined. In a case where the remaining battery cycle count is less than the remaining battery cycle threshold, the second early warning signal is generated, indicating that the battery cycle count is about to be exhausted. A third early warning signal generation unit is included. The third early warning signal generation unit is configured to determine, in a case where the battery usage time is less than the maximum battery usage time threshold and the remaining battery cycle count is greater than or equal to the remaining battery cycle threshold, whether the remaining battery life percentage is less than or equal to the minimum battery life percentage threshold, and generate, if so, a third early warning signal. Specifically, for a battery whose battery usage time is less than the maximum battery usage time threshold and whose remaining battery cycle count is greater than or equal to the remaining battery cycle threshold, whether the remaining battery life percentage is less than or equal to the minimum battery life percentage threshold is further determined. In a case where the remaining battery life percentage is less than or equal to the minimum battery life percentage threshold, the third early warning signal is generated, indicating that the remaining battery life percentage has dropped to a lower level. An early warning response unit is included. The early warning response unit is configured to perform an early warning response based on the first early warning signal, the second early warning signal, and the third early warning signal, and output the early warning signal. Specifically, the early warning response unit receives the first early warning signal, the second early warning signal, and the third early warning signal, generates corresponding early warning signals according to different early warning signal types, and sends the corresponding early warning signals to the early warning platform. According to the implementation, the battery state parameter analysis unit, the threshold setting unit, the remaining battery life data extraction unit, the first early warning signal generation unit, the second early warning signal generation unit, the third early warning signal generation unit, and the early warning response unit are set. Accordingly, multi-dimensional analysis and determination are performed on the battery state parameter. Combined with a threshold setting, the health condition and usage of the battery are accurately determined, and corresponding early warning signals are generated under different circumstances. A technical effect of implementing multi-level, comprehensive, and refined early warning on the battery life is achieved.

An intelligent alarm device 60 is included. The intelligent alarm device 60 is configured to receive the early warning signal based on the early warning platform to activate an alarm device, and connect a remote terminal through the alarm device to perform intelligent alarming on battery life of the mobile energy storage apparatus. The intelligent alarm device 60 is a device responsible for receiving the early warning signals, analyzing a signal content, activating the alarm device, and sending alarm information to the remote terminal, to improve safety and reliability of battery management. Specifically, the intelligent alarm device 60 receives an early warning signal from the early warning signal output device 50 through the early warning platform (a central platform for receiving, processing, and distributing early warning signals). The early warning signal contains specific information about the battery state, such as the battery thermal runaway risk, the battery life decline rate, and the remaining battery life. The intelligent alarm device 60 analyzes the early warning signal, and determines whether to activate the alarm device (a physical apparatus or system configured to generate an alarm signal) according to an analyzed content of the early warning signal. If necessary, an activation instruction is sent to the alarm device. The alarm device includes a light flasher, a vibrator, etc., to attract the attention of a user. The intelligent alarm device 60 generates detailed alarm information according to the analyzed content of the early warning signal. The detailed alarm information includes the current state of the battery, existing risks, recommended measures, etc. The intelligent alarm device 60 sends the generated alarm information to the remote terminal through a communication protocol and connection manner preset by the alarm device. The remote terminal may be a monitoring center, a mobile device of a manager, or another remote monitoring system. After receiving the alarm information, the remote terminal displays or plays an alarm content, such that relevant personnel can understand the current state of the battery and possible risks in a timely manner. In the embodiments of the present disclosure, the historical battery thermal runaway log is analyzed, then the battery thermal runaway parameter set is generated, real-time monitoring is performed on the mobile energy storage apparatus, parameter comparison is performed, the battery life early warning model is built, the early warning signal is output, and the intelligent alarm is performed for battery life. According to the above technological means, technical effects of improving accuracy and reliability of early warning, and providing a strong guarantee for safe operation of mobile energy storage apparatuses are achieved.

In a possible implementation, the intelligent alarm device 60 includes an abnormal parameter set acquisition unit. The abnormal parameter set acquisition unit is configured to decompose the early warning signal to acquire an abnormal parameter set, and send the abnormal parameter set to the remote terminal through the alarm device for alarming. Specifically, the abnormal parameter set acquisition unit receives the early warning signal from the early warning signal output device 50, analyzes the early warning signal, and extracts parameters related to battery abnormality to form the abnormal parameter set. The abnormal parameter set is a set of parameters related to an abnormal battery state, is used to describe the current abnormal state of the battery, includes an abnormal temperature value, an abnormal current value, an abnormal voltage value, etc. of the battery, and sends the abnormal parameter set to the remote terminal through the alarm device, such that the manager can understand battery abnormal conditions in a timely manner. An adjustment parameter set generation unit is included. The adjustment parameter set generation unit is configured to return a battery optimization strategy through the remote terminal, perform the battery optimization strategy in combination with the apparatus battery operating parameter to adjust an initial battery usage strategy of the mobile energy storage apparatus, and generate an adjustment parameter set. Specifically, the adjustment parameter set generation unit receives the battery optimization strategy, including adjusting a charging current, adjusting a discharge depth, changing a battery usage manner, etc., from the remote terminal, adjusts the initial battery usage strategy of the mobile energy storage apparatus in combination with the apparatus battery operating parameter (such as current battery temperature, a charge rate, and a discharge rate) and the received battery optimization strategy, and generates the adjustment parameter set according to an adjustment result. The adjustment parameter set is a parameter set used to adjust the battery usage strategy, and includes a new charging current value, discharge depth limits, battery usage manner, etc. A parameter adjustment unit is included. The parameter adjustment unit is configured to adjust the thermal runaway time data, the thermal runaway location data, and the thermal runaway battery state according to the adjustment parameter set, and acquire a battery usage time adjustment parameter, a battery usage location adjustment parameter, and a battery usage state adjustment parameter. Specifically, the parameter adjustment unit receives the adjustment parameter set, adjusts parameters related to the battery performance and the usage manner in the thermal runaway time data, the thermal runaway location data, and the thermal runaway battery state according to the adjustment parameter set, and extracts the battery usage time adjustment parameter, the battery usage location adjustment parameter, the battery usage state adjustment parameter, etc. from the adjusted parameters. A battery life data update unit is included. The battery life data update unit is configured to update battery life data of the mobile energy storage apparatus based on the battery usage time adjustment parameter, the battery usage location adjustment parameter, and the battery usage state adjustment parameter. Specifically, the battery life data update unit receives the battery usage time adjustment parameter, the battery usage location adjustment parameter, and the battery usage state adjustment parameter from the parameter adjustment unit, updates the battery life data of the mobile energy storage apparatus according to the adjustment parameters, and specifically, includes updating expected remaining life of the battery, adjusting a battery maintenance plan, etc. According to the implementation, the abnormal parameter set acquisition unit, the adjustment parameter set generation unit, the parameter adjustment unit, and the battery life data update unit are set. Accordingly, the battery usage strategy is dynamically adjusted according to a real-time status and usage conditions of the battery. Technical effects of extending the service life of the battery and improving the performance and safety of the battery are achieved.

Although the present disclosure makes various references to some devices in the platform according to the embodiments of the present disclosure, any number of different devices may be used and run on a user terminal and/or server. The units and devices included are only divided according to functional logic, but are not limited to the above division, as long as corresponding functions can be implemented. Moreover, the specific names of the functional units are only used for distinguishing one another, and are not intended to limit the scope of protection of the of the present disclosure.

The above specific implementations do not limit the scope of protection of the present disclosure. Those skilled in the art will appreciate that various modifications, combinations, and substitutions may be made according to design requirements and other factors. Modifications, equivalent substitutions, improvements, etc. within the spirit and principles of the present disclosure are intended to fall within the scope of protection of the present disclosure. In some cases, the actions or steps recited in the present disclosure may be performed in an order different from those in the embodiments and still realize the desired results. Also, the processes depicted in the accompanying figures do not necessarily require the specific order shown or a successive order to realize the desired results. Multitasking and parallel processing are also possible or may be advantageous in some implementations.

1. A battery life early warning platform for a mobile energy storage apparatus based on battery thermal runaway analysis, comprising:
a battery thermal runaway parameter set generation device, wherein the battery thermal runaway parameter set generation device is configured to retrieve a historical battery thermal runaway log to analyze the mobile energy storage apparatus, and generate a battery thermal runaway parameter set, and the battery thermal runaway parameter set comprises a thermal runaway reaction parameter and a thermal runaway trigger parameter;
an apparatus battery operating parameter acquisition device, wherein the apparatus battery operating parameter acquisition device is configured to acquire an apparatus battery operating parameter through real-time monitoring of the mobile energy storage apparatus;
a parameter comparison device, wherein the parameter comparison device is configured to compare the apparatus battery operating parameter with the thermal runaway reaction parameter by taking the thermal runaway trigger parameter as a constraint condition, and generate a parameter comparison result;
a battery life early warning model building device, wherein the battery life early warning model building device is configured to build a battery life early warning model and synchronize the parameter comparison result to the battery life early warning model, and the battery life early warning model comprises a battery life analysis channel and a battery life early warning channel;
an early warning signal output device, wherein the early warning signal output device is configured to acquire a battery state parameter through the battery life analysis channel, and input the battery state parameter into the battery life early warning channel to output an early warning signal; and
an intelligent alarm device, wherein the intelligent alarm device is configured to receive the early warning signal based on the early warning platform to activate an alarm device, and connect a remote terminal through the alarm device to perform intelligent alarming on battery life of the mobile energy storage apparatus;
the battery life early warning model building device comprises:
a life influencing feature extraction unit, wherein the life influencing feature extraction unit is configured to extract a life influencing feature according to a battery life influencing parameter of the mobile energy storage apparatus;
a plurality of decision tree building units, wherein the plurality of decision tree building units are configured to use a random forest to build a plurality of decision trees based on the life influencing feature;
a battery life analysis channel building unit, wherein the battery life analysis channel building unit is configured to perform cross-validation on the plurality of decision trees, and build the battery life analysis channel;
a splitting criterion performance unit, wherein the splitting criterion performance unit is configured to perform splitting criteria on the plurality of decision trees according to a maximum depth, and generate a performance result;
a battery life early warning channel building unit, wherein the battery life early warning channel building unit is configured to perform unsupervised training for battery life on the mobile energy storage apparatus based on the performance result, and build the battery life early warning channel according to a training result; and
a channel fusion unit, wherein the channel fusion unit is configured to fuse the battery life analysis channel and the battery life early warning channel, and build the battery life early warning model.

2. The battery life early warning platform for a mobile energy storage apparatus based on battery thermal runaway analysis according to claim 1, wherein the battery thermal runaway parameter set generation device comprises:
a historical operating thermal runaway event extraction unit, wherein the historical operating thermal runaway event extraction unit is configured to analyze the historical battery thermal runaway log and extract a historical operating thermal runaway event of the mobile energy storage apparatus, and the historical operating thermal runaway event comprises thermal runaway time data, thermal runaway location data, and a thermal runaway battery state;
a battery short-circuit trigger record generation unit, wherein the battery short-circuit trigger record generation unit is configured to perform trigger analysis based on the thermal runaway battery state and generate a battery short-circuit trigger record;
a battery overcharge and overdischarge trigger record generation unit, wherein the battery overcharge and overdischarge trigger record generation unit is configured to perform trigger analysis based on the thermal runaway battery state in combination with the thermal runaway time data, and generate a battery overcharge trigger record and a battery overdischarge trigger record;
an ambient temperature trigger record generation unit, wherein the ambient temperature trigger record generation unit is configured to perform trigger analysis based on the thermal runaway location data and generate an ambient temperature trigger record; and
a thermal runaway trigger parameter determination unit, wherein the thermal runaway trigger parameter determination unit is configured to integrate the battery short-circuit trigger record, the battery overcharge trigger record, the battery overdischarge trigger record, and the ambient temperature trigger record to determine the thermal runaway trigger parameter.

3. The battery life early warning platform for a mobile energy storage apparatus based on battery thermal runaway analysis according to claim 2, wherein the battery thermal runaway parameter set generation device comprises:
a thermal runaway temperature record data acquisition unit, wherein the thermal runaway temperature record data acquisition unit is configured to identify a battery state change of the mobile energy storage apparatus according to the historical operating thermal runaway event, and acquire thermal runaway temperature record data, and the thermal runaway temperature record data comprises a thermal runaway initial temperature, a thermal runaway peak temperature, and a thermal runaway temperature change rate;
a thermal runaway voltage and current data acquisition unit, wherein the thermal runaway voltage and current data acquisition unit is configured to analyze a power parameter change in the historical operating thermal runaway event, and acquire thermal runaway voltage data and thermal runaway current data;
a thermal runaway reaction rate data acquisition unit, wherein the thermal runaway reaction rate data acquisition unit is configured to perform calculations based on the thermal runaway voltage data and the thermal runaway current data, and obtain thermal runaway reaction rate data; and
a thermal runaway reaction parameter determination unit, wherein the thermal runaway reaction parameter determination unit is configured to integrate the thermal runaway temperature record data and the thermal runaway reaction rate data to determine the thermal runaway reaction parameter.

4. The battery life early warning platform for a mobile energy storage apparatus based on battery thermal runaway analysis according to claim 3, wherein the parameter comparison device comprises:
a plurality of trigger frequency determination units, wherein the plurality of trigger frequency determination units are configured to determine a plurality of trigger frequencies based on the battery short-circuit trigger record, the battery overcharge trigger record, the battery overdischarge trigger record, and the ambient temperature trigger record;
a constraint condition determination unit, wherein the constraint condition determination unit is configured to extract, based on the plurality of trigger frequencies, a trigger record that leads to a battery thermal runaway result, and determine the constraint condition;
a thermal runaway critical value determination unit, wherein the thermal runaway critical value determination unit is configured to analyze a thermal runaway characteristic according to the thermal runaway initial temperature, the thermal runaway peak temperature, and the thermal runaway temperature change rate, and determine a thermal runaway critical value;
a comparison and determination unit, wherein the comparison and determination unit is configured to compare the apparatus battery operating parameter and the thermal runaway reaction parameter according to the constraint condition, and determine whether the apparatus battery operating parameter reaches the thermal runaway critical value;
a battery thermal runaway risk parameter acquisition unit, wherein the battery thermal runaway risk parameter acquisition unit is configured to determine that the mobile energy storage apparatus has a battery thermal runaway risk in a case where the apparatus battery operating parameter reaches the thermal runaway critical value, and acquire a battery thermal runaway risk parameter, and
a parameter comparison result adding unit, wherein the parameter comparison result adding unit is configured to add the battery thermal runaway risk parameter to the parameter comparison result.

5. The battery life early warning platform for a mobile energy storage apparatus based on battery thermal runaway analysis according to claim 4, wherein the early warning signal output device comprises:
a battery thermal runaway risk parameter input unit, wherein the battery thermal runaway risk parameter input unit is configured to extract the battery thermal runaway risk parameter from the parameter comparison result, and input the battery thermal runaway risk parameter into the battery life analysis channel;
a battery life decline rate data generation unit, wherein the battery life decline rate data generation unit is configured to calculate a change trend according to the battery thermal runaway risk parameter and the apparatus battery operating parameter, and generate battery life decline rate data;
a remaining battery life data generation unit, wherein the remaining battery life data generation unit is configured to perform life evaluation on the mobile energy storage apparatus according to the battery life decline rate data, and generate remaining battery life data; and
a battery state parameter output unit, wherein the battery state parameter output unit is configured to integrate the battery life decline rate data and the remaining battery life data to output the battery state parameter through the battery life analysis channel.

6. The battery life early warning platform for a mobile energy storage apparatus based on battery thermal runaway analysis according to claim 5, wherein the early warning signal output device comprises:
a battery state parameter analysis unit, wherein the battery state parameter analysis unit is configured to analyze the battery state parameter and acquire a battery life percentage, a battery cycle count, and battery usage time;
a threshold setting unit, wherein the threshold setting unit is configured to set a minimum battery life percentage threshold based on the battery life percentage, set a remaining battery cycle threshold based on the battery cycle count, and set a maximum battery usage time threshold based on the battery usage time;
a remaining battery life data extraction unit, wherein the remaining battery life data extraction unit is configured to extract a remaining battery life percentage, a remaining battery cycle count, and battery usage time of the remaining battery life data based on the battery life decline rate data;
a first early warning signal generation unit, wherein the first early warning signal generation unit is configured to generate a first early warning signal in a case where the battery usage time is greater than or equal to the maximum battery usage time threshold;
a second early warning signal generation unit, wherein the second early warning signal generation unit is configured to determine, in a case where the battery usage time is less than the maximum battery usage time threshold, whether the remaining battery cycle count is less than the remaining battery cycle threshold, and generate, if so, a second early warning signal;
a third early warning signal generation unit, wherein the third early warning signal generation unit is configured to determine, in a case where the battery usage time is less than the maximum battery usage time threshold and the remaining battery cycle count is greater than or equal to the remaining battery cycle threshold, whether the remaining battery life percentage is less than or equal to the minimum battery life percentage threshold, and generate, if so, a third early warning signal; and
an early warning response unit, wherein the early warning response unit is configured to perform an early warning response based on the first early warning signal, the second early warning signal, and the third early warning signal, and output the early warning signal.

7. The battery life early warning platform for a mobile energy storage apparatus based on battery thermal runaway analysis according to claim 2, wherein the intelligent alarm device comprises:
an abnormal parameter set acquisition unit, wherein the abnormal parameter set acquisition unit is configured to decompose the early warning signal to acquire an abnormal parameter set, and send the abnormal parameter set to the remote terminal through the alarm device for alarming;
an adjustment parameter set generation unit, wherein the adjustment parameter set generation unit is configured to return a battery optimization strategy through the remote terminal, perform the battery optimization strategy in combination with the apparatus battery operating parameter to adjust an initial battery usage strategy of the mobile energy storage apparatus, and generate an adjustment parameter set;
a parameter adjustment unit, wherein the parameter adjustment unit is configured to adjust the thermal runaway time data, the thermal runaway location data, and the thermal runaway battery state according to the adjustment parameter set, and acquire a battery usage time adjustment parameter, a battery usage location adjustment parameter, and a battery usage state adjustment parameter; and
a battery life data update unit, wherein the battery life data update unit is configured to update battery life data of the mobile energy storage apparatus based on the battery usage time adjustment parameter, the battery usage location adjustment parameter, and the battery usage state adjustment parameter.
